(19) United States
(12) Patent Application Publication
(10) Pub. No.: US 2006/0181645 A1
(43) Pub. Date: Aug. 17, 2006

(54) TV and method of setting wallpaper or screen saver mode thereof

(75) Inventor: Lamba Sarika, (US)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/271,884

(22) Filed: Nov. 14, 2005

(30) Foreign Application Priority Data
Feb. 14, 2005 (KR) 10-2005-0011883

(51) Int. Cl. H04N 5/44; H04N 5/445

(52) U.S. Cl. 348/563; 348/706; 348/553

(57) ABSTRACT

A TV and method for setting a wallpaper or screen saver (WPSS) mode are provided in which the TV includes a user selection part; a plurality of image sources to store a playback image for the WPSS mode; and a controller to execute the WPSS mode when no broadcasting signal is detected, wherein when one of the image sources is selected for the WPSS mode through the user selection part, the controller loads the playback image from the selected image source and executes the WPSS mode with the loaded playback image. Thus, a user may select and edit a desired playback image for display in the WPSS mode.

### CROSS-REFERENCE TO RELATED APPLICATIONS

This application claims priority from Korean Patent Application No. 10-2005-0011883, filed on Feb. 14, 2005 in the Korean Intellectual Property Office, the entire disclosure of which is incorporated herein by reference.

### BACKGROUND OF THE INVENTION

1. Field of the Invention

Apparatuses and methods consistent with the present invention relate to a television (TV) having a wallpaper or screen saver (WPSS) mode, and a method of setting the WPSS mode thereof.

1. Description of the Related Art

In a conventional TV, a blue screen, a white screen or a black screen has been used as a default screen of when the TV does not receive a broadcast signal or an external video signal. Also, a predetermined color pattern has been used as the default screen.

Previously, there has been introduced a TV capable of using a wallpaper or a screen saver for an advertisement or a decoration. However, such a TV is inconvenient for a user to set a wallpaper or screen saver (WPSS) mode through a remote controller or the like.

Generally, a TV with the WPSS mode previously stores a playback image in its internal memory when the TV is manufactured. Further, a user can load the TV with an external playback image stored in an external storage, so that the TV can use the external playback image in the WPSS mode. However, a user cannot freely edit the loaded playback image or an accompanying sound through the TV.

### SUMMARY OF THE INVENTION

Accordingly, it is an aspect of the present invention to provide a TV and a method of setting a WPSS mode thereof, in which a WPSS mode is executed in response to no signal input to the TV, various image sources for the WPSS mode are provided for allowing a user to select a playback image as desired, and an editing function is supported for allowing a user to freely edit the playback image of the WPSS mode.

According to an aspect of the present invention, there is provided a TV comprising a broadcasting receiver to receive a broadcasting signal, and a signal processor to process the broadcasting signal, and alternating between a normal mode and a WPSS mode, the TV further comprising a user selection part; a plurality of image sources to store a playback image for the WPSS mode; and a controller to execute the WPSS mode when no broadcasting signal is detected, wherein when one of the image sources is selected for the WPSS mode through the user selection part, the controller loads the playback image from the selected image source and executes the WPSS mode with the loaded playback image.

According to an aspect of the present invention, the plurality of image sources may include at least one of an external storage, a captured image captured from the broadcast signal or an external signal, and an internal memory.

According to an aspect of the present invention, the external storage may include at least one of a camera, a cellular phone, a personal computer, and a memory stick.

According to an aspect of the present invention, the controller edits the playback image on the basis of selections of the user selection part when an edition function for the WPSS mode is selected through the user selection part, and executes the WPSS mode with the edited playback image.

According to an aspect of the present invention, the editing function comprises at least one of a text editor, a graphics editor, and a sound editor.

According to an aspect of the present invention, the user selection part allows a user to select an execution period of the WPSS mode, and the controller executes the WPSS mode with the playback image during the execution period selected through the user selection part.

According to an aspect of the present invention, there is provided a TV which alternates between a normal mode and a WPSS mode, comprising a user selection part; an image source to store a playback image for the WPSS mode; and a controller to edit the playback image on the basis of selection of the user selection part when an edition function for the WPSS mode is selected, and execute the WPSS mode with the edited playback image.

According to an aspect of the present invention, the editing function comprises at least one of a text editor, a graphics editor, and a sound editor.

According to an aspect of the present invention, the user selection part allows a user to select an execution period of the WPSS mode, and the controller executes the WPSS mode with the playback image during the execution period selected through the user selection part.

According to an aspect of the present invention, there is provided a method of setting a WPSS mode of a TV, comprising detecting whether a broadcasting signal is input; executing the WPSS mode when no broadcasting signal is detected; displaying a menu related to a plurality of image sources which include a playback image for the WPSS mode when a user desires to newly set the WPSS mode; selecting one of the plurality of image sources; loading the playback image for the WPSS mode from the selected image source; and executing the WPSS mode with the loaded playback image.

According to an aspect of the present invention, the plurality of image sources for the WPSS mode may include at least one of an external storage, a captured image captured from the broadcast signal or an external signal, and an internal memory.

According to an aspect of the present invention, the external storage may include at least one of a camera, a cellular phone, a personal computer, and a memory stick.

According to an aspect of the present invention, the method further comprises selecting an editing function for the playback image of the WPSS mode; and executing the WPSS mode with the playback image edited by a user through the editing function.

According to an aspect of the present invention, the method further comprises selecting an execution period of the WPSS mode; and executing the WPSS mode with the playback image during the selected execution period.

### BRIEF DESCRIPTION OF THE DRAWINGS

The above and other aspects of the present invention will become more apparent from the following description of the following exemplary embodiments, taken in conjunction with the accompany drawings of which:

FIG. 1 is a control block diagram of a TV according to a first exemplary embodiment of the present invention;

FIG. 2 is a control flowchart of setting a WPSS mode of the TV according to the first exemplary embodiment of the present invention;

FIG. 3 is a control flowchart of editing a playback image in a WPSS mode of a TV according to a second exemplary embodiment of the present invention; and

FIG. 4 is a control flowchart of setting a period of executing the WPSS mode of the TV according to the second exemplary embodiment of the present invention.

### DETAILED DESCRIPTION OF THE EXEMPLARY EMBODIMENTS OF THE INVENTION

Reference will now be made in detail to exemplary embodiments of the present invention, examples of which are illustrated in the accompanying drawings, wherein like reference numerals refer to like elements throughout. The exemplary embodiments are described below so as to explain the present invention more fully with reference to the accompanying figures.

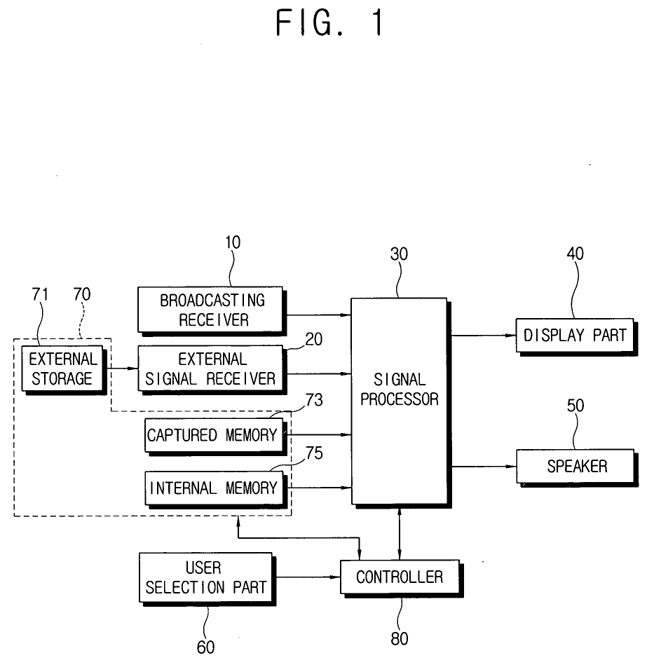

FIG. 1 is a control block diagram of a TV according to a first exemplary embodiment of the present invention.

As shown in FIG. 1, a TV according to a first exemplary embodiment of the present invention comprises a broadcasting receiver 10; a signal processor 30 to process a received signal; a display part 40 to display an image based on a processed signal; a speaker 50 to output a sound based on the processed signal; a user selection part 60 to receive a user input; an image source 70 to store a playback image for a WPSS mode; and a controller 80 to generally control the broadcasting receiver 10, the signal processor 30, the display part 40, the speaker 50, the user selection part 60 and the image source 70. Here, the TV alternates between a normal mode and the WPSS mode.

The normal mode refers to the TV displaying an image and outputting sound on the basis of a received and processed broadcasting signal. Further, the WPSS mode refers to the TV displaying an image, which may include outputting sound, on the basis of wallpaper or a screen saver. Also, the normal mode may additionally include the TV displaying an image and outputting a sound on the basis of an external signal which is received from an external source.

The broadcasting receiver 10 comprises an antenna to receive a tuned broadcasting signal.

According to the first exemplary embodiment of the present invention, the TV further comprises an external signal receiver 20 to receive an external signal from the external source. Here, the external signal receiver 20 comprises an input terminal to which a connection cable from the external source is connected. For example, the external signal receiver 20 comprises a plurality of input terminals to receive an external signal such as an S-video signal, a component signal, a personal computer (PC) signal, a digital video interface (DVI) signal, etc. corresponding to various external sources.

Also, the external signal receiver 20 comprises a terminal connected to an external storage 71 that stores a playback image for the WPSS mode. For example, the terminal connected to the external storage 71 may comprise a universal serial bus (USB) port or a PC port to which a compact disc read only memory (CD-ROM), a memory stick, a camera, a cellular phone, etc. can be connected.

According to the first exemplary embodiment of the present invention, the signal processor 30 processes a signal received through the external signal receiver 20 and/or the broadcasting receiver 10, or the playback image for the WPSS mode from the image source 70 to have a format to be outputted through the display part 40 and the speaker 50.

The signal processor 30 comprises a tuner to tune a channel selected by a user; an analog/digital (A/D) converter to convert an analog signal such as the component signal or the PC-signal into a digital signal; and a transition minimized differential signaling (TMDS) receiver to separate the DVI signal into red (R), green (G) and blue (B) digital signals and horizontal/vertical (H/V) signal.

Further, the signal processor 30 comprises a decoder to decode the playback image of the image source 70 in the WPSS mode. Additionally, the decoder may decode a composite video baseband signal (CVBS) or the S-video signal.

Here, the decoder may decode either of a moving picture or a still picture in various formats as the playback image for the WPSS mode. For example, the decoder may decode data having various formats such as MPEG JPEG, GIF, etc.

Also, the signal processor 30 can comprise an encoder to encode an image which has been captured from the broadcasting signal and/or the external signal into data having a predetermined format.

Additionally, the signal processor 30 may comprise a scaler to convert the processed signal to have a vertical frequency, a resolution, an aspect ratio, etc. suitable for the display part 40, and a frame buffer to store the processed video signal as a unit of frame.

Further, the signal processor 30 comprises an audio signal processor to process an audio signal. Here, the audio signal processor may comprise a D/A converter to convert the processed audio signal into an analog signal, thereby outputting a sound through the speaker 50.

The display part 40 displays an image based on a video signal which is processed by the signal processor 30. According to an exemplary embodiment of the present invention, the display part 40 can be achieved by various displays such as a cathode ray tube (CRT), a digital light processing (DLP) display, a liquid crystal display (LCD), a plasma display panel (PDP), or the like.

The user selection part 60 allows a user to set and select the WPSS mode, etc., and is achieved by a key, a button, a touch screen or the like, which may be provided in a remote controller or located on the television. Further, the user selection part 60 can comprise an on screen display (OSD) generator to generate an OSD menu and to set and select the WPSS mode according to control of the controller 80.

The image source 70 stores the playback image for the WPSS mode. As shown in FIG. 1, the image source 70 comprises an external storage 71, a captured image 73 which has been captured from the broadcasting signal or the external signal, and an internal memory 75. Here, the playback image may be a still picture or a moving picture.

External storage 71 may include a camera, a cellular phone, a personal computer, a memory stick, or the like. Therefore, the TV receives a corresponding playback image from the external storage 71 through the external signal receiver 20. The capture image 73 is a playback image, which is captured from the broadcasting signal or the external signal stored in the frame buffer. Also, the internal memory 75 is achieved by a random access memory (RAM), a flash ROM, or the like. To make the TV support the WPSS mode, a playback image for the WPSS mode may be stored in the internal memory 75 of the TV when it is produced. Also, a user can store and update a desired playback image while using the TV.

According to the first exemplary embodiment of the present invention, the controller 80 detects whether the broadcasting signal is input, and executes the WPSS mode if no broadcasting signal is detected. Further, the controller 80 controls the display part 40 to display a corresponding OSD menu when a function for setting the WPSS mode is selected through the user selection part 60, and generally controls the signal processor 30 or the like to perform a corresponding function according to selection of the user selection part 60. Here, the controller 80 can be achieved by a micro control unit (MCU), a central processing unit (CPU), or the like.

When a user selects the normal mode to be changed to the WPSS mode through the user selection part 60, the controller 80 controls the signal processor 30 to display a preset playback image for the WPSS mode on the display part 40. On the other hand, if a user selects the WPSS mode to be changed to the normal mode through the user selection part 60, the controller 80 likewise changes the modes.

In the case where no broadcasting signal or external signal is detected, the controller 80 automatically executes the WPSS mode, and a desired image can be selected from various image sources 70.

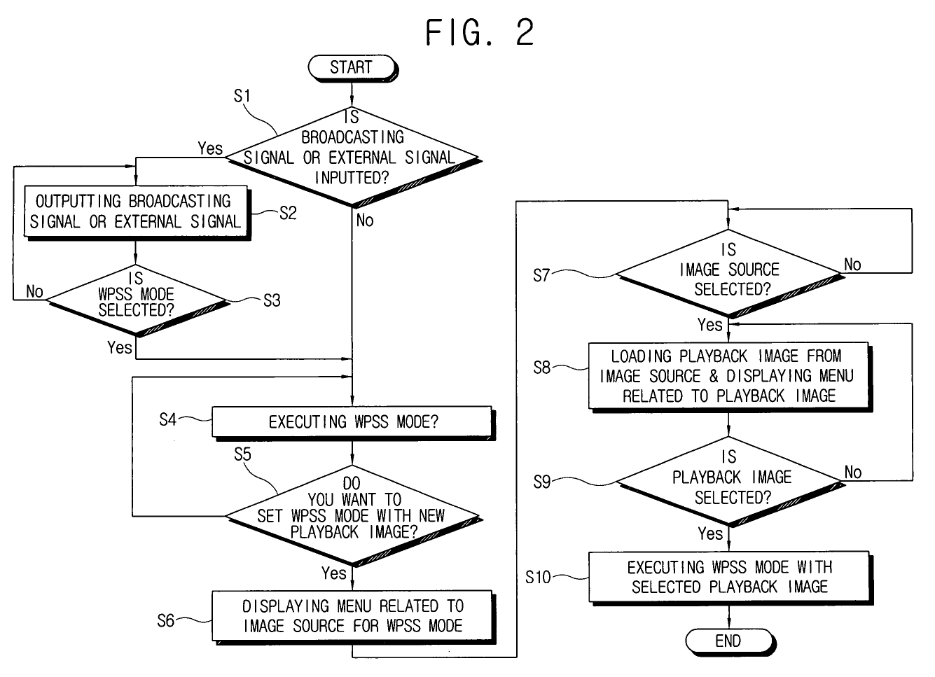

Hereinbelow, operations of executing the WPSS mode according to the first exemplary embodiment of the present invention will be described with reference to FIG. 2.

Referring to FIG. 2, when the TV is turned on, the controller 80 detects whether the broadcasting signal is input at operation S1. Meanwhile, if the TV can process the external signal in addition to the broadcasting signal, the controller 80 further detects whether the external signal is input. Generally, the TV is set as a default to receive the broadcasting signal, so that the priority of the detection is given to the broadcasting signal. At operation S2, the controller 80 receives, processes and outputs the broadcasting signal when the broadcasting signal is detected; detects the external signal of the external source when there is no broadcasting signal input; and receives, processes and outputs the external signal when the external signal is detected.

If no broadcasting signal input and/or no external signal input is detected in operation S1, the controller 80 automatically executes the WPSS mode at operation S4.

In the meantime, when the WPSS mode is selected at operation S3 through the user selection part 60 while the TV outputs the broadcasting signal or the external signal in the normal mode, the controller 80 controls the signal processor 30 to execute the WPSS mode at operation S4.

Here, when the playback image for the WPSS mode is not previously selected or a user selects a new playback image for the WPSS mode at operation S5, the controller 80 controls the display part 40 to display the OSD menu for setting the WPSS mode at operation S6. The OSD menu contains items for selecting the image source 70 which includes the playback image for the WPSS mode, wherein the image source 70 includes the external storage 71, the captured image 73 which has been captured from the current broadcasting signal or the current external signal, and the external source 75.

When a user selects the image source 70 which includes the playback image for the WPSS mode through the user selection part 60 at operation S7, the controller 80 reads out the playback image from the selected image source 70 at operation S8. Here, when a user selects a currently displayed image corresponding to the broadcasting signal or the external signal as the image source 70 for the WPSS mode, the controller 80 controls the signal processor 30 to capture a corresponding image stored in the current frame buffer. Further, a playback image which is loaded from the external storage 71 or a playback image which is captured from the broadcasting signal or the external signal can be stored in the internal memory 75.

When a plurality of playback images are loaded, the controller 80 controls the display part 40 to show information about the plurality of playback images at operation S8. Thus, at operation S9, a user can select a desired playback image on the basis of the information about the plurality of playback images which is shown in the display part 40.

Then, at operation S10, the controller 80 sets and stores the playback image selected by a user as the image source 70 for the WPSS mode. The controller then controls the signal processor 30 to execute the WPSS mode with the selected playback image.

Thus, the TV according to the first exemplary embodiment of the present invention automatically executes the WPSS mode to provide a desired visual display even when no broadcasting signal or external signal is received. Here, a user can deactivate the automatic execution of the WPSS mode through the user selection part 60, and thus a user can select or cancel the automatic execution of the WPSS mode as desired. Further, when the WPSS mode is set, a user can load various playback images from the plurality of image sources 70 and select a desired playback image as the image source 70 in the WPSS mode.

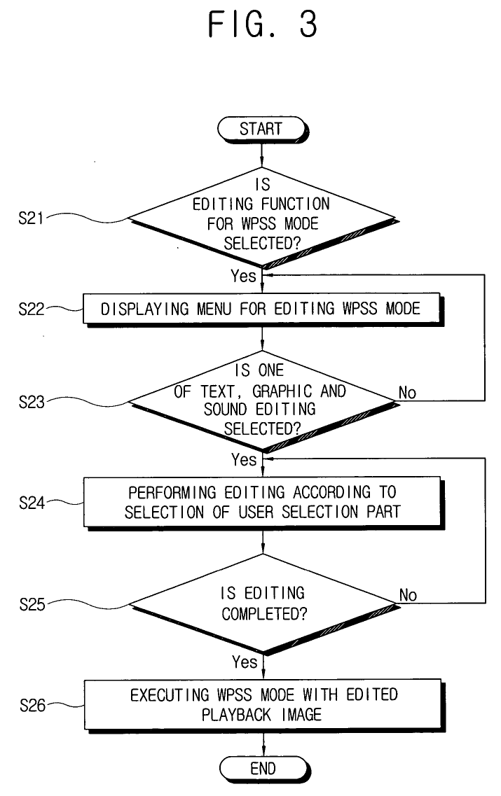

Hereinbelow, a TV with a WPSS mode according to a second exemplary embodiment of the present invention and a control method thereof will be described with reference to FIGS. 1 and 3. Here, repetitive description to the foregoing embodiments will be avoided as necessary.

A user can select an editing function with regard to a playback image for the WPSS mode through the user selection part 60. Further, a user can input commands for editing the playback image through the user selection part 60. Here, the user selection part 60 may include a word processor when a text or the like is edited.

The signal processor 30 includes a software program for editing the playback image, and thus the editing function for the WPSS mode is performed through the software program on the basis of the control of the controller 80. For example, the signal processor 30 may include graphics editing software for editing images for the WPSS display. In the case of editing text, a language or a phrase can be selected. In the case of a sound edition, a greeting message of a user may be recorded and played back while the playback image is displayed in the WPSS mode. Further, in the case of the sound edition, a desired music can be played together with the playback image of the WPSS mode. Here, the sound edition may be achieved directly using a microphone or the like.

Such an edition function is performed by the signal processor 30 on the basis of the control of the controller 80 in accordance with input of the user selection part 60. At this time, a user can edit a desired playback image loaded from the image source 70. Further, a default image may be provided, and a user can insert desired text or other images in the default image, thereby allowing a user to easily edit the playback image of the WPSS.

Further, a user can set a plurality of still images to be sequentially displayed as a slideshow.

FIG. 3 is a control flowchart of editing the playback image in the WPSS mode of the TV according to a second exemplary embodiment of the present invention.

Referring to FIG. 3, when the editing function for the playback image is selected through the user selection part 60 at operation S21, the controller 80 generates a menu for editing the playback image of the WPSS mode and displays the menu on the display part 40 at operation S22.

Thus, a user can edit not only the playback image loaded from the image source 70, but also a new playback image through the user selection part 60.

At operation S23, a user can select one of a text editing function, a graphic editing function, and a sound editing function in the OSD menu through the user selection part 60.

At operation S24, the controller 80 drives a corresponding editing program to operate the editing function selected by a user, and controls the signal processor 30 to achieve the edition according to inputs of the user selection part 60.

When the editing is completed at operation S35, the controller 80 executes the WPSS mode with the edited playback image. Here, the edited playback image may be stored in the internal memory 75.

Thus, a user can edit a desired still picture or a desired moving picture and use it as the playback image for the WPSS mode.

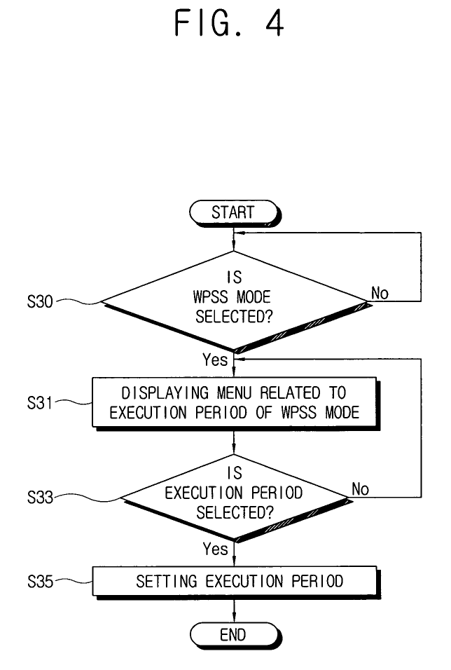

Hereinbelow, operations of setting time in the WPSS mode of the TV according to the second exemplary embodiment of the present invention will be described with reference to FIG. 4.

When a user selects a function for setting the WPSS mode through the user selection part 60 at operation S30, the controller 80 generates the OSD menu related to setting the WPSS mode and displays the OSD menu on the display part 40. Here, the OSD menu which is displayed on the display part 40 includes a menu related to an execution period of the WPSS mode at operation S31.

When a user selects or inputs a period of time for executing the WPSS mode through the user selection part 60 at operation S33, the controller 80 sets the selected or input period at operation S35, thereby executing the WPSS mode for the period set by a user. After a lapse of the execution period, the WPSS mode can be automatically changed to the normal mode. As necessary, the controller 80 can inform a user that the execution period of the WPSS mode is ended through the display part 40, thereby allowing a user to prolong the execution period of the WPSS mode.

Further, in the case where the WPSS mode is automatically executed after the lapse of a predetermined period in the normal mode, a user can select or input a period through the user selection part 60, thereby causing the WPSS mode to be executed during a desired period.

Therefore, it is convenient for a user to select and input the period of executing the WPSS mode.

As described above, aspects of the present invention provide a TV and a method of setting a WPSS mode thereof, in which a WPSS mode is executed in response to detecting no signal input, various image sources for the WPSS mode are provided for allowing a user to select a desired playback image, and an editing function is supported for allowing a user to freely edit the playback image which is displayed in WPSS mode.

Although exemplary embodiments of the present invention have been shown and described, it will be appreciated by those skilled in the art that changes may be made to the exemplary embodiments without departing from the principles and spirit of the invention, the scope of which is defined in the appended claims and their equivalents.

What is claimed is:

1. A television (TV) having a normal mode and a wallpaper or screen saver mode (WPSS) mode, the TV comprising:
a user selection part;
a plurality of image sources which store playback images for the WPSS mode which are selected by the user selection part; and
a controller which executes the WPSS mode to display a playback image from one of the plurality of image sources which is selected if no broadcasting signal is detected,
wherein, the controller loads the playback image from an image source which is selected and executes the WPSS mode to display the loaded playback image if one of the plurality of image sources is selected for display in the WPSS mode through the user selection part.

2. The TV according to claim 1, wherein the plurality of image sources includes at least one of an external storage, a captured image which is captured from the broadcast signal or an external signal, and an internal memory.

3. The TV according to claim 2, wherein the external storage includes at least one of a camera, a cellular phone, a personal computer, and a memory stick.

4. The TV according to claim 1, wherein the controller edits the playback image on the basis of selections of the user selection part if an editing function of the WPSS mode is selected through the user selection part, and the controller executes the WPSS mode to display the playback image which is edited.

5. The TV according to claim 4, wherein the editing function comprises at least one of a text editor, a graphics editor, and a sound editor.

6. The TV according to claim 1, wherein the user selection part allows a user to select an execution period of the WPSS mode, and
the controller executes the WPSS mode to display playback image during the execution period which is selected by the user selection part.

7. A television (TV) having a normal mode and a wallpaper or screen saver (WPSS) mode, the TV comprising:
a user selection part;
an image source which stores a playback image for the WPSS mode; and
a controller which edits the playback image which is stored by the image source on the basis of selection of the user selection part if an editing function of the WPSS mode is selected, and executes the WPSS mode to display the playback image which is edited.

8. The TV according to claim 6, wherein the editing function comprises at least one of a text editor, a graphics editor, and a sound editor.

9. The TV according to claim 6, wherein the user selection part selects an execution period in which the WPSS mode is executed, and
the controller executes the WPSS mode to display the playback image during the execution period which is selected by the user selection part.

10. A method of setting a wallpaper or screen saver (WPSS) mode of a television (TV), the method comprising:
detecting whether a broadcasting signal is input;
executing the WPSS mode if no broadcasting signal is detected;
displaying a menu of a plurality of image sources which store playback images for the WPSS mode if a command to set the WPSS mode is received;
selecting an image source from the menu;
loading a playback image for the WPSS mode from the image source which is selected; and
executing the WPSS mode to display the playback image which is loaded.

11. The method according to claim 10, wherein the plurality of image sources includes at least one of an external storage, a captured image which is captured from the broadcast signal or an external signal, and an internal memory.

12. The method according to claim 11, wherein the external storage includes at least one of a camera, a cellular phone, a personal computer, and a memory stick.

13. The method according to claim 10, further comprising:
selecting an editing function in which the playback image of the WPSS mode is edited; and
executing the WPSS mode to display the playback image which has been edited by a user with the editing function.

14. The method according to claim 13, wherein the editing function comprises at least one of a text editor, a graphics editor, and a sound editor.

15. The method according to claim 13, further comprising:
selecting an execution period of the WPSS mode; and
executing the WPSS mode to display the playback image during the execution period which is selected.

16. The method according to claim 10, further comprising:
selecting an execution period in which the WPSS mode is executed; and
executing the WPSS mode to display the playback image during the execution period which is selected.
